(19) United States
(12) Patent Application Publication
(10) Pub. No.: US 2003/0142493 A1
(43) Pub. Date: Jul. 31, 2003

(54) Lamp string

(76) Inventor: Hsi-Huang Lin, Taipei City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/247,724

(22) Filed: Sep. 17, 2002

(30) Foreign Application Priority Data
Jan. 25, 2002 (TW) 091200777

(51) Int. Cl. F21V 21/005

(52) U.S. Cl. 362/249; 362/5; 362/252; 362/236; 362/800; 362/806; 362/808

(57) ABSTRACT

A lamp string includes a plurality of insulator bases, a plurality of conducting strips, and a plurality of illuminating devices. Each of the conducting strips is mounted fixedly on an adjacent pair of the insulator bases. Each of the illuminating devices bridges an adjacent pair of the conducting strips on a respective one of the insulator bases.

### CROSS-REFERENCE TO RELATED APPLICATION

This application claims priority of Taiwanese Application No. 091200777, filed on Jan. 25, 2002.

### BACKGROUND OF THE INVENTION

1. Field of the Invention

This invention relates to a lamp string, more particularly to a lamp string which can be manufactured in an automated manner with minimal cost.

2. Description of the Related Art

FIG. 1 shows a conventional lamp string used as decorations for special occasions, such as Christmas. In the conventional lamp string 1, the illuminating device 10, such as a light bulb 2 shown in FIG. 2 or a light emitting diode lamp 3 shown in FIG. 3, is usually connected to a conducting wire unit 11 manually. This is because each of the conventional light bulb 2 or the light emitting diode lamp 3 is formed with either a base 21 or a pair of terminals 31 adapted to be electrically connected to other devices. Therefore, in view of the structure of the conventional illuminating device 10, the illuminating devices 10 can only be inserted into lamp sockets 12 on the conducting wire unit 11 manually. Since the conventional illuminating devices 10 do not contemplate direct formation of the same on the conducting wire unit 11, in order to form a lamp string by using the conventional manner, the illuminating devices 10 have to be inserted into the lamp sockets 12 individually and manually, which results in waste of materials and human resources.

### SUMMARY OF THE INVENTION

Therefore, the main object of the present invention is to provide a lamp string that can be manufactured in an automated manner with minimal cost.

According to this invention, the lamp string comprises a plurality of insulator bases, and a plurality of conducting strips, each of which has a first end portion and a second end portion opposite to the first end portion. The first and second end portions of each of the conducting strips are mounted fixedly on a corresponding adjacent pair of the insulator bases such that each of the insulator bases has the first and second end portions of an adjacent pair of the conducting strips mounted thereon with a spacing formed between the adjacent pair of the conducting strips. The lamp string further comprises a plurality of illuminating devices, each of which is fixed on a respective one of the insulator bases and bridges together the first and second end portions of the adjacent pair of the conducting strips that are mounted on the respective one of the insulator bases.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 illustrates a conventional lamp string;

FIG. 2 illustrates a conventional light bulb;

FIG. 3 illustrates a conventional light emitting diode lamp;

FIG. 4 is a partly sectional schematic top view showing a lamp string of the first preferred embodiment of this invention;

FIG. 5 is a partly sectional schematic side view showing the lamp string of the first preferred embodiment of this invention;

FIG. 6 illustrates a light emitting diode of the first preferred embodiment;

FIG. 7 is a partly sectional schematic top view showing a lamp string of the second preferred embodiment of this invention; and

FIG. 8 is a partly sectional schematic side view showing the lamp string of the second preferred embodiment of this invention.

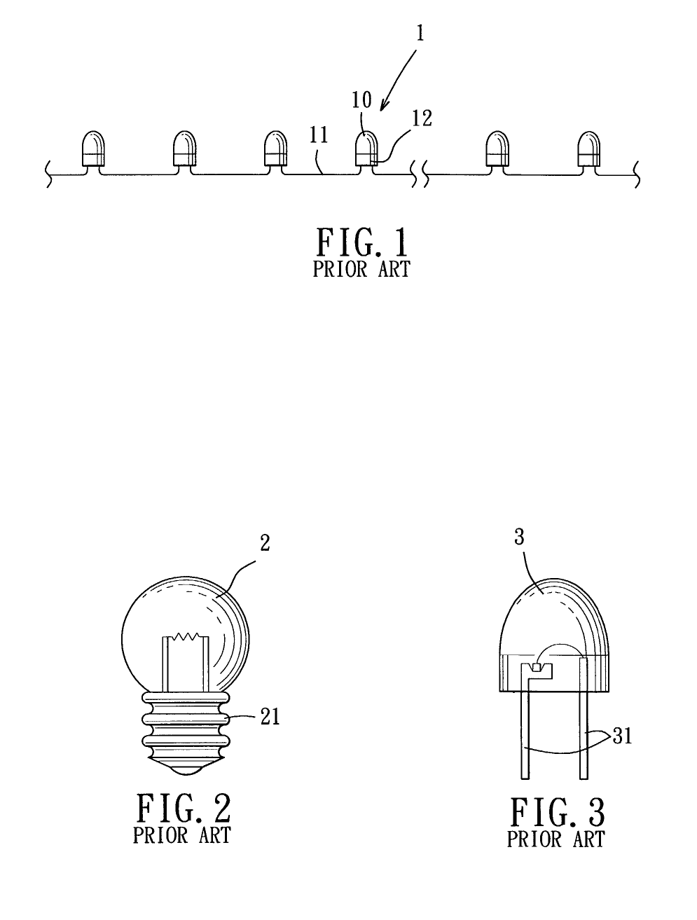

### DETAILED DESCRIPTION OF THE PREFERRED EMBODIMENTS

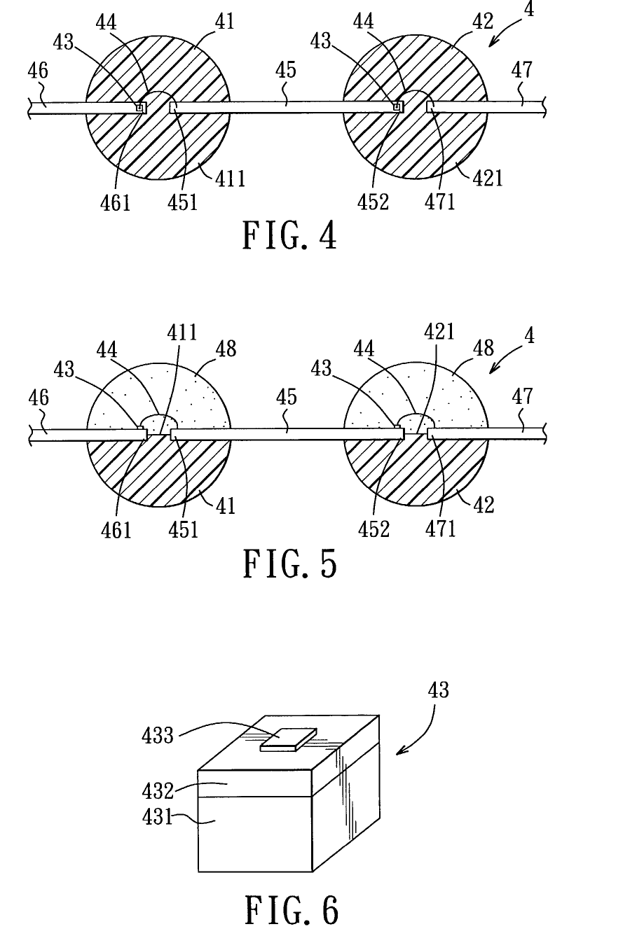

Referring to FIGS. 4 and 5, the first preferred embodiment of the lamp string 4 according to the present invention is shown to comprise a plurality of insulator bases (only two insulator bases 41, 42 are shown), a plurality of conducting strips (only three conducting strips 45, 46, 47 are shown), and a plurality of illuminating devices 43 (only two are shown).

Each of the conducting strips 45, 46, 47 has a first end portion and a second end portion opposite to the first end portion. With reference to the conducting strip 45, the first and second end portions 451, 452 of the conducting strip 45 are mounted fixedly on a corresponding adjacent pair of the insulator bases 41, 42. Each of the insulator bases 41, 42 has the first end portion 451, 471 and the second end portion 461, 452 of an adjacent pair of the conducting strips 45, 46, 47 mounted thereon with a spacing formed between the adjacent pair of the conducting strips 45, 46, 47.

Each of the illuminating devices 43 is fixed on and bridges together the first end portion 451, 471 and the second end portion 461, 452 of the adjacent pair of the conducting strips 45, 46, 47 that are mounted on a respective insulator base 41, 42.

The insulator bases 41, 42 may or may not be formed from a transparent material and are formed as hemispherical bodies with flat surfaces 411, 421. The flat surfaces 411, 421 are used for mounting the first end portion 451, 471 and the second end portion 461, 452 of the adjacent pair of the conducting strips 45, 46, 47 thereon.

In this embodiment, the illuminating device 43 includes a light emitting diode, the structure of which is shown in FIG. 6. The light emitting diode 43 has a p-terminal 431 and an n-terminal 432. Ametal contact 433 is connected to the n-terminal 432. As shown in FIGS. 4 and 5, the p-terminal 431 is electrically connected to the second end portion 461, 452 of one of the conducting strips 45, 46, 47 on a respective insulator base 41, 42 via a conductive paste. A metal wire 44 is used for bonding the metal contact 433 to the first end portion 451, 471 of the other one of the conducting strips 45, 46, 47 in the adjacent pair on the respective one of the insulator bases 41, 42.

Moreover, each of a plurality of transparent cap members 48 is mounted on a respective one of the insulator bases 41, 42 and covers one of the illuminating devices 43 and the first end portion 451, 471 and the second end portion 461, 452 of the adjacent pair of the conducting strips 45, 46, 47 that are mounted on the respective insulator base 41, 42. Preferably, the transparent cap member 48 is formed as a hemispherical shell to complement the respective insulator base 41, 42.

Thus, when the two outermost conducting strips of the lamp string 4 of the present invention are electrically connected to positive and negative terminals of a power supply, respectively, the light emitting diodes 43 will be enabled to emit light via the electrically connected conducting strips 45, 46, 47.

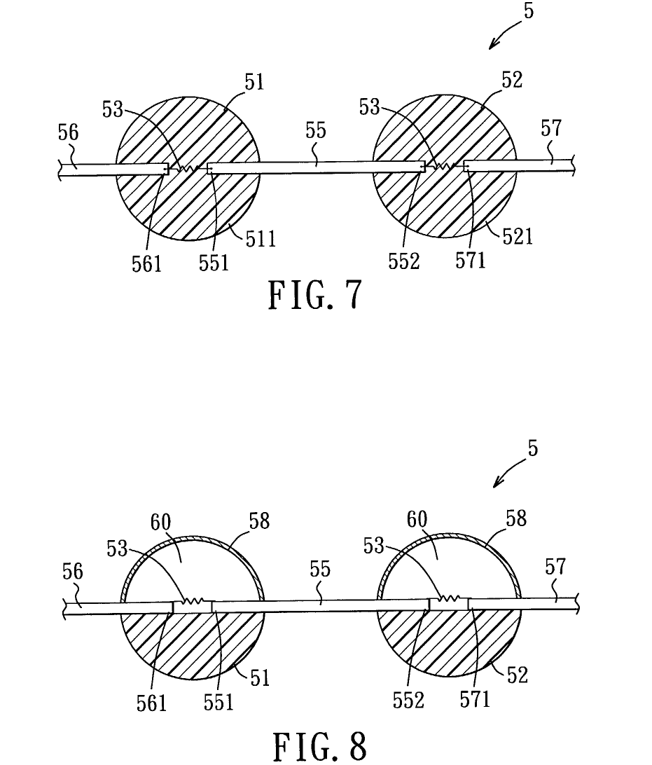

Referring to FIGS. 7 and 8, the second preferred embodiment of the lamp string 5 of the present invention is shown to include a plurality of insulator bases (only two insulator bases 51, 52 are shown), a plurality of conducting strips (only three strips 55, 56, 57 are shown), and a plurality of illuminating devices 53 (only two are shown). The structural relationships among these elements are essentially the same as those of the first preferred embodiment, the main difference residing in that each illuminating device 53 of the second preferred embodiment is a lamp filament which electrically connects the first end portion 551, 571 and the second end portion 561, 552 of the adjacent pair of the conducting strips 55, 56, 57 that are mounted on the respective insulator base 51, 52. Each of the insulator bases 51, 52 is further provided with a transparent cap member 58, similar to the cap member 48 of the previous embodiment. Each cap member 58 cooperates with the respective insulator base 51,52 to confine a vacuumed interior 60.

The preferred embodiments of the present invention can be manufactured in an automated manner. With reference to the lamp string 4, the first end portion 451, 471 and the second end portion 461, 452 of each of the conducting strips 45, 46, 47 are mounted fixedly on a corresponding adjacent pair of the insulator bases 41, 42 such that each of the insulator bases 41, 42 has the first end portion 451, 471 and the second end portion 461, 452 of an adjacent pair of the conducting strips 45, 46, 47 mounted thereon with a spacing formed between the adjacent pair of the conducting strips 45, 46, 47. Then, each of the illuminating devices 43 is fixed on and bridges together the first end portion 451, 471 and the second end portion 461, 452 of the adjacent pair of the conducting strips 45, 46, 47 that are mounted on a respective one of the insulator bases 4l, 42. Thereafter, each of the transparent cap members 48 is mounted on a respective one of the insulator bases 41, 42 and covers one of the illuminating devices 43 and the first end portions 451, 471 and the second end portions 461, 452 of the adjacent pair of the conducting strips 45, 46, 47 that are mounted on the respective one of the insulator bases 41, 42. Moreover, in the second preferred embodiment, because the illuminating device is a lamp filament 53, the manufacturing process further involves the step of vacuuming the interior 60 confined by each cap member 58 and the respective insulator base 51, 52.

It is evident from the aforesaid that the lamp string of the present invention can be manufactured in an automated manner, which not only saves human resources but also increases productivity.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A lamp string comprising:
a plurality of insulator bases;
a plurality of conducting strips, each of which has a first end portion and a second end portion opposite to said first end portion, said first and second end portions of each of said conducting strips being mounted fixedly on a corresponding adjacent pair of said insulator bases such that each of said insulator bases has said first and second end portions of an adjacent pair of said conducting strips mounted thereon with a spacing formed between the adjacent pair of said conducting strips; and
a plurality of illuminating devices, each of which is fixed on and bridges together said first and second end portions of the adjacent pair of said conducting strips that are mounted on a respective one of said insulator bases.

2. The lamp string as claimed in claim 1, further comprising a plurality of transparent cap members, each of which is mounted on a respective one of said insulator bases and covers one of said illuminating devices and said first and second end portions of the adjacent pair of said conducting strips that are mounted on the respective one of said insulator bases.

3. The lamp string as claimed in claim 2, wherein each of said cap members is formed as a hemispherical shell.

4. The lamp string as claimed in claim 3, wherein each of said insulator bases is formed as a hemispherical body with a flat surface for mounting said first and second end portions of the adjacent pair of said conducting strips thereon.

5. The lamp string as claimed in claim 1, wherein each of said illuminating devices includes:
a light emitting diode connected electrically to said second end portion of one of said conducting strips in the adjacent pair on the respective one of said insulator bases, and having a metal contact; and
a metal wire for bonding said metal contact to said first end portion of the other one of said conducting strips in the adjacent pair on the respective one of said insulator bases.

6. The lamp string as claimed in claim 1, wherein each of said illuminating devices includes a lamp filament.

7. The lamp string as claimed in claim 6, further comprising a plurality of transparent cap members, each of which is mounted on a respective one of said insulator bases and covers one of said illuminating devices and said first and second end portions of the adjacent pair of said conducting strips that are mounted on the respective one of said insulator bases, each of said cap members cooperating with the respective one of said insulator bases to confine a vacuumed interior.
